(19) United States
(12) Patent Application Publication
(10) Pub. No.: US 2017/0187608 A1
(43) Pub. Date: Jun. 29, 2017

(54) SYSTEM FOR ENABLING MULTICAST IN AN OPENFLOW NETWORK

(71) Applicants: Tejas Subhash Nevrekar, Bangalore (IN); Saurabh Aditya, Bangalore (IN); Iyappa Swaminathan BJ, Bangalore (IN); Sridhararao Kothe, Bangalore (IN); Sreenivas Devalla, Milpitas, CA (US)

(72) Inventors: Tejas Subhash Nevrekar, Bangalore (IN); Saurabh Aditya, Bangalore (IN); Iyappa Swaminathan BJ, Bangalore (IN); Sridhararao Kothe, Bangalore (IN); Sreenivas Devalla, Milpitas, CA (US)

(73) Assignee: Nuviso Networks Inc, Milpitas, CA (US)

(21) Appl. No.: 15/458,031

(22) Filed: Mar. 14, 2017

(51) Int. Cl. H04L 12/751; H04L 12/761

(52) U.S. Cl. CPC H04L 45/02; H04L 45/16

(57) ABSTRACT

An embodiment provides a system for enabling multicast in an OpenFlow network. The system includes a controller (102), configured to receive a request from a requesting node to join an existing multicast tree. The controller (102) is further configured to select a connecting node among multicast nodes. The multicast nodes are part of the multicast tree. The connecting node is selected such that it is least number of hops away from the requesting node. A data flow path is defined between the requesting node and the connecting node, thereby maintaining/ensuring a non-disruptive packet flow in the multicast tree.

### BACKGROUND

Unless otherwise indicated herein, the materials described in this section are not prior art to the claims in this application and are not admitted to be prior art by inclusion in this section.

### Field

The subject matter in general relates to OpenFlow networks. More particularly, the subject matter relates to establishing multicast tree, adding new members to and deleting existing members from the multicast tree in OpenFlow networks.

### Discussion of Related Art

Point to MultiPoint (P2MP) communication paths are used to multicast a data stream to a large number of client nodes from a single serving node. Conventionally, when a client node sends a request to join a multicast tree, a data flow path to the client node is defined. The path is optimized such that a shortest path between a serving node and the client node is established. In establishing this shortest path, a brute force approach may be employed. In this approach, at least some of the existing data flow paths of the multicast tree may be terminated, and new paths may be created. Such termination may cause temporary disruption in data flow. The disruption may result in loss of data packets while delivering to the client nodes whose data flow paths may have been affected by the termination. Several applications require data packets to be delivered in a timely manner, and such delivery of data is often mission critical. Loss of data packets can adversely affect the operation of such applications.

Additionally, defining data flow path to client node that has to be made part of the multicast, with the sole objective of establishing the shortest path between the serving node and the client node, often requires some of the nodes of the OpenFlow network, which are not otherwise part of the multicast tree, to be made a part of the multicast tree. Such addition of nodes to the multicast tree may result in utilization of network bandwidth in a sub-optimum manner.

In light of these foregoing problems with known techniques, there is a need for an improved technique for enabling multicast in an OpenFlow network.

### SUMMARY

An embodiment provides a system for enabling multicast in an OpenFlow network. The system includes a controller, configured to receive a request from a requesting node to join an existing multicast tree. The controller is further configured to select a connecting node among multicast nodes, the multicast nodes being part of the multicast tree. The connecting node is selected such that it is least number of hops away from the requesting node. The controller defines a data flow path between the requesting node and the connecting node, thereby maintaining/ensuring a non-disruptive packet flow in the multicast tree.

### BRIEF DESCRIPTION OF THE DRAWINGS

Embodiments are illustrated by way of example and not limitation in the Figures of the accompanying drawings, in which like references indicate similar elements and in which:

FIG. 1 is block diagram of an exemplary architecture of an exemplary controller 100 configured to enable multicast in an OpenFlow network;

FIG. 2A is a flow chart of an example method of initiating multicast;

FIG. 2B is an example multicast tree that is established upon initiation of a multicast session;

FIG. 3A is an example multicast tree that is expanded to add a requesting node N9 to the multicast tree of FIG. 2B;

FIG. 3B is an example multicast tree that is expanded to add a requesting node N8 to the multicast tree of FIG. 2A;

FIGS. 4A and 4B are flowcharts of an example method of adding a requesting node to a multicast tree; and

FIG. 5 is a flowchart of an example method of deleting a multicast node from the multicast tree of FIG. 3B.

### DETAILED DESCRIPTION

I. OVERVIEW
II. OPENFLOW INFRASTRUCTURE
III. SYSTEM ARCHITECTURE
IV. CREATION OF MULTICAST TREE
V. DATA ENCAPSULATION
VI. ADDITION OF NEW NODES TO A MULTICAST TREE
VIE DELETION OF EXISTING NODES FROM MULTICAST TREE
VIII. CONCLUSION

The following detailed description includes references to the accompanying drawings, which form part of the detailed description. The drawings show illustrations in accordance with example embodiments. These example embodiments are described in enough detail to enable those skilled in the art to practice the present subject matter. However, it will be apparent to one of ordinary skill in the art that the present invention may be practiced without these specific details. In other instances, well-known methods, procedures and components have not been described in detail so as not to unnecessarily obscure aspects of the embodiments. The embodiments can be combined, other embodiments can be utilized or structural and logical changes can be made without departing from the scope of the invention. The following detailed description is, therefore, not to be taken as a limiting sense.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated.

### I. Overview

Embodiments provide a system for enabling multi cast in an OpenFlow network. The system enables a topology independent multicast in an OpenFlow network. The system includes a controller configured to initiate multicasting by defining a multicast tree with a source node and one or more destination nodes. The multicast tree, at the initiation of multicast, is defined by establishing data flow paths between the source node and each of the destination nodes, which are all part of the initial multicast. The data flow paths may be defined, such that the multicast tree is balanced or has the shortest paths between the source node and each of the destination nodes.

The controller controls the flow of data packets along the multicast tree by updating flow tables of each of the nodes that are part of the multicast tree. As per the instruction of the controller, the data packets may be encapsulated at the source node to create a tunnel, and the tunnel may be provided with an identification. Further, each of the multicast nodes carries out actions as per the flow table by identifying the tunnel by its identification. At some of the multicast nodes, data flow may diverge into two or more paths. At such multicast nodes, as per the instruction from the controller, as many copies of the packet as the number of paths the data flow diverges into are created, and each copy is sent along a data flow path. In other words, the tunnel extends along the number of paths the data flow is diverging at respective multicast nodes.

The controller is further configured to add new nodes to an existing multicast tree and delete existing nodes from a multicast tree. Referring to the addition of new nodes to an existing multicast tree, the controller may receive a request from a requesting node to join an existing multicast tree. A connecting node, among multicast nodes that are part of the multicast tree, is selected. A data flow path between the requesting node and the connecting node is defined. The data flow path defined between the requesting node and the connecting node ensures a non-disruptive packet flow in the multicast tree. The connecting node is least number of hops away from the requesting node.

Referring to the deletion of a node from a multicast tree, the controller may receive a request from one of the multicast nodes, which are the destination nodes that requested data from the multicast tree, to exit the multicast tree. A node, among the multicast nodes, which is immediately upstream from the node requesting to exit and which enables more than one flow paths downstream, wherein one of the flow paths leads to the node requesting to exit, is identified. The flow table of the identified node is updated. The flow path leading to the node requesting to exit is terminated.

### II. OpenFlow Infrastructure

In an OpenFlow network infrastructure, controllers are configured to define the path of network packets across a network of switches/nodes/routers. The controllers are centralized and are distinct from the switches or nodes between which multicast is formed. OpenFlow separates the packet forwarding (data path) and the high-level routing decisions (control path). OpenFlow enables software defined networking (SDN).

The controllers of the OpenFlow environment may define one or more paths between a source and a plurality of destination nodes. In OpenFlow, routing decisions between each node can be made by the controller(s), which are then deployed to a node's flow table. Based on the flow table, packets which are matched by a node, are delivered to their respective destination nodes. Information about packets which are unmatched by a node can be forwarded to the controller. The controller may then modify existing flow table rules on one or more nodes to deploy new rules. OpenFlow controllers serve as an operating system (OS) for the network. The controller facilitates automated network management and makes it easier to integrate and administer various applications.

To work in an OpenFlow environment, any device that wants to communicate with the controller must support the OpenFlow protocol. Through this interface, the controller pushes down changes to the node/router flow-table allowing partitioning of traffic, controlling flows for optimal performance, and enabling definition of new configurations and applications.

### III. System Architecture

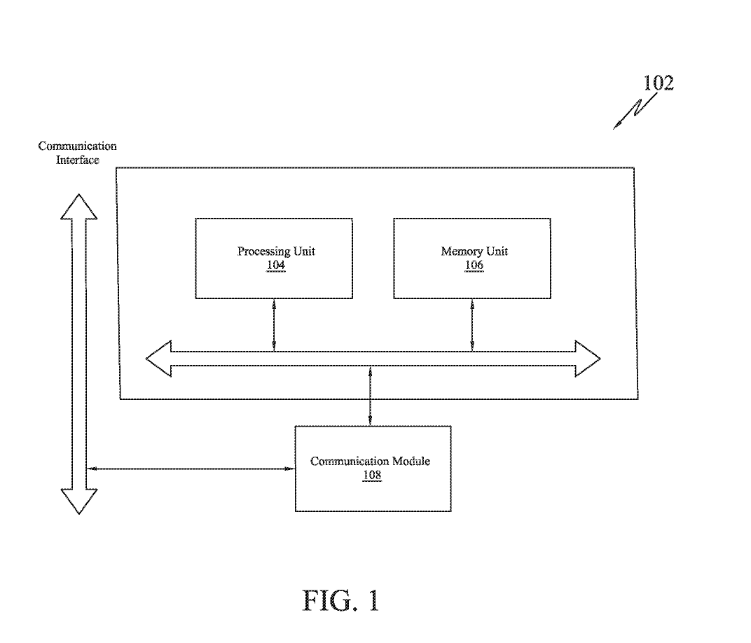

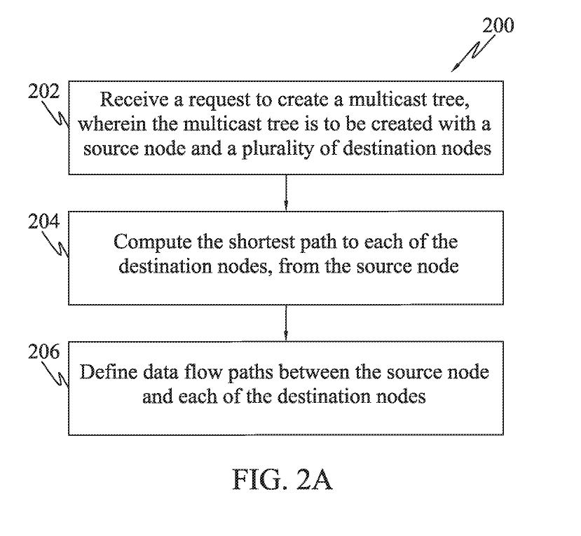

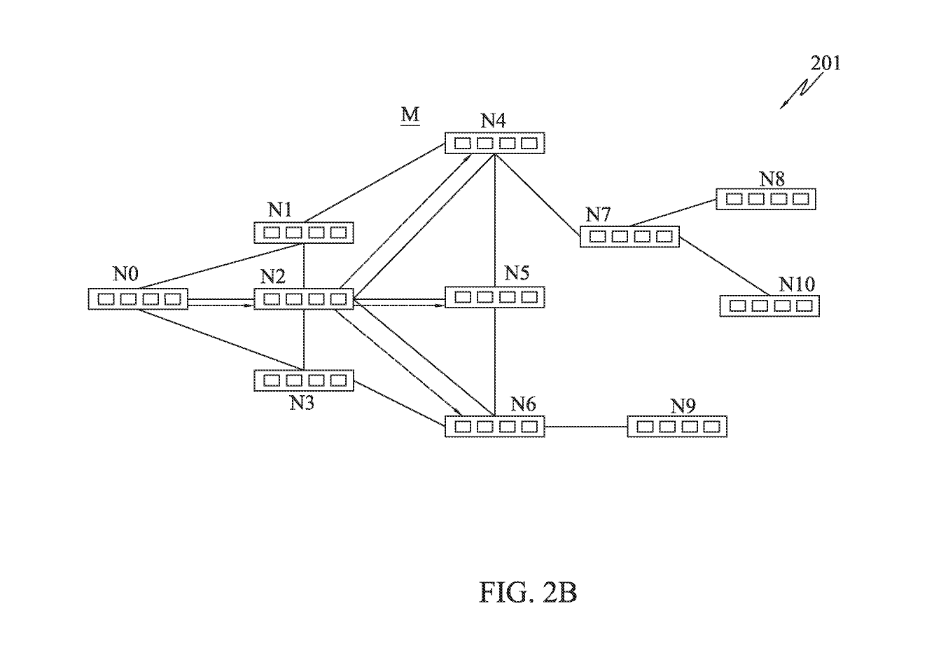

In an embodiment, a system for enabling multicast in an OpenFlow network is provided. The system may include a controller and a computer network. An exemplary controller 102 is illustrated in FIG. 1, and an exemplary computer network 201 is illustrated in FIG. 2B.

Referring to the figures, and more particularly to FIG. 1, an exemplary architecture of a controller 102 for enabling multicast in an OpenFlow network is provided. In this section the system components/modules are discussed.

Controller 102 may be an SDN controller enabled to define traffic paths and rules in the OpenFlow network. Controller 102 is configured to manage flow control to the various nodes. Controller 102 may be configured to modify existing flow tables at each node.

Controller 102 is configured to enable operation of the computer network 201 (illustrated in FIG. 2B) through a centralized software that dictates how the network behaves. The controller 102 uses OpenFlow protocol to configure network devices and choose the network path for traffic.

Controller 102 may include one or more processing unit 104, memory units/devices 106 and a communication module 108. Additional modules may also be present to enable multicast in the OpenFlow network.

Processing unit 104, returns output by accepting signals, such as electrical signals as input. In one embodiment, the controller 102 may include one or more processing units (CPUs). The processing unit 104 may be implemented as appropriate in hardware, computer-executable instructions, firmware, or combinations thereof. Computer-executable instruction or firmware implementations of the processing unit 104 may include computer-executable or machine-executable instructions written in any suitable programming language to perform the various functions described.

The memory units/devices 106 may store data and program instructions that are loadable and executable on processing unit 104 as well as data generated during the execution of these programs. The memory may be volatile, such as random access memory and/or a disk drive or non-volatile memory.

The communication module 108 of the controller 102 may enable communication with the OpenFlow network nodes. Standard communication protocols may be used to enable controller 102 to communicate with the network nodes. Information corresponding to updating of a flow table, information corresponding to configuration of a node, status of a port and information corresponding to requests from the network nodes, among others, may be communicated between the controller 102 and one or more of the network nodes.

### IV. Creation of Multicast Tree

In this section, initiation of multicast by defining a multicast tree between network nodes will be elaborated. The controller 102 of the system enables defining the traffic flow paths between network nodes. The multicast tree is created between a source node and a plurality of destination nodes, wherein the paths originating at the source node and leading to the destination nodes, are defined by the controller 102.

FIG. 2A is a flowchart illustrating a method 200 of initiating multicast by creating a multicast tree M between a source node and a plurality of destination nodes. At step 202, the controller 102 receives a request to initiate a multicast by creating a multicast tree M, wherein the multicast tree M is to be created with a source node and a plurality of destination nodes. At step 204, the controller 102 may compute the shortest path to each of the destination nodes, from the source node. Shortest paths are determined by considering the number of hops from the source node to each of the destination nodes. At step 206, data flow paths between the source node and each of the destination nodes are defined along the shortest paths that are determined. The data flow paths may be selected such that the network is balanced.

In an embodiment, while creating the shortest path between the source node and destination nodes, the controller 102 attempt to identify at least one multicast node within the network 201, at which more than one data flow paths diverge to reach the destination nodes. The multicast node at which more than one data flow paths diverges may be referred to as a point or node of divergence. The controller 102 may provide instructions to the source node to define a single data flow path to the node of divergence at which the data flow paths diverge, such that only one instance of data packet is communicated through each data flow path. The node of divergence may be identified by traversing, from each of the destination nodes, towards the source node. Hence, in effect, the controller 102 identifies common links in the flow paths between the source node and each of the destination nodes and defines data flow paths between the source node and each of the destination nodes such that single data flow is established in the common links as well.

FIG. 2B is an example, illustrating initiation of a multicast by creation of the multicast tree M. The network infrastructure 201 comprises plurality of network nodes N0-N10. Each node in the network infrastructure 201 may have physical connection with one or more remaining nodes. The physical connections are illustrated by solid lines. Network nodes may be, as examples, switches or routers.

In this example, the node N0 may be a node at which the multicast data packets originate and may be referred to as source node. The source node may be, as an example, connected to a server (a web server or an application server, among other servers).

In this example, request to initiate multicast may be received wherein N0 may be the source node, and N4, N5 and N6 are the nodes to which data packets have to be communicated. N4, N5 and N6 may be referred to as destination nodes. Referring to step 204, the controller 102 is configured to compute the shortest paths to each of the destination nodes N4, N5 and N6 from source node N0 by determining the number of hops. The shortest path may be chosen such that the multicast tree is balanced. Upon computing the shortest path, the controller 102 may define paths from the source node N0 to each of N4, N5 and N6.

As an example, the shortest path to N4 may include N0→N 1→N4 and N0→N2→N4. The shortest path to N5 includes N0→N2→N5. Likewise, the shortest path to N6 may include N0→N3→N6 and N0→N2→N6. The controller 102 attempts to identify the shortest paths. In this example, the shortest path that may be chosen to reach the destination nodes are N0→N2→N4, N0→N2→N5 and N0→N2→N6. The shortest paths are selected such that the network is balanced.

In the above example, the controller 102 identifies multicast node N2, at which more than one data flow paths diverge to reach the destination nodes N4, N5 and N6. The controller 102, thus establishes node N2 as the common link in the flow paths between the source node N0 and each of the destination nodes N4, N5 and N6. Data flow paths are defined between the source node N0 and each of the destination nodes N4, N5 and N6 such that single data flow is established in the common link N2.

Referring to step 206, the controller 102 defines data flow paths upon selecting the path between the source node N0 and each of the destination nodes (N4, N5 and N6) requesting data from the source node N0. Each of the nodes N0, N2, N4, N5 and N6 may be referred to as multicast nodes, since they are now part of the multicast tree. Each multicast node and the paths defined from the node N0 to the each of nodes N2, N4, N5 and N6 form the multicast tree M.

The edges (connecting paths) of the multicast tree M may be referred to as network links. Each node (N0, N2, N4, N5 and N6) is a member of the multicast tree.

### V. Data Encapsulation

Each of the multicast nodes within the tree M comprises flow tables. Flow tables, as known in the art, comprises matches or rules indicating configuration or status of the multicast nodes which are part of the multicast tree and actions to be performed at the multicast nodes if a match is valid as per the flow table. As an example, matches include combinations of the one or more of source identification data (source MAC, source IP), destination identification data (destination MAC, destination IP) and ports identification data (port IDs), among other information. As an example, actions may include “forward to port 1, if match is valid”.

As per the instruction of the controller 102, the data packets may be encapsulated at the source node. A tunnel encapsulating the data packets is created at the source node and the tunnel may be provided a unique identification. The identification or identifier format is supported by the technologies that is used to encapsulate the data packets. The unique identification may be common to all the copies of data packets that are created during a multicast session. The tunnel is identified across the multicast network by the tunnel identification.

Further, at each of the multicast nodes, the tunnel is identified by the tunnel identification. Each of the multicast nodes carries out actions as per the flow table by identifying the tunnel. At some of the multicast nodes, data flow may diverge into two or more paths. At such multicast nodes, as per the instruction from the controller 102, as many copies of the data packets may be created as the number of paths the data flow diverges into and the tunnel encapsulating the data packets may be extended along the number of paths the data flow diverges into. Each copy of the data packets is sent along a data flow path.

information corresponding to flow tables at each multicast node may be stored in the memory unit 106 of the controller 102. Information corresponding to tunnel identification may be stored in the memory unit 106.

### VI. Addition if New Nodes to A Multicast Tree

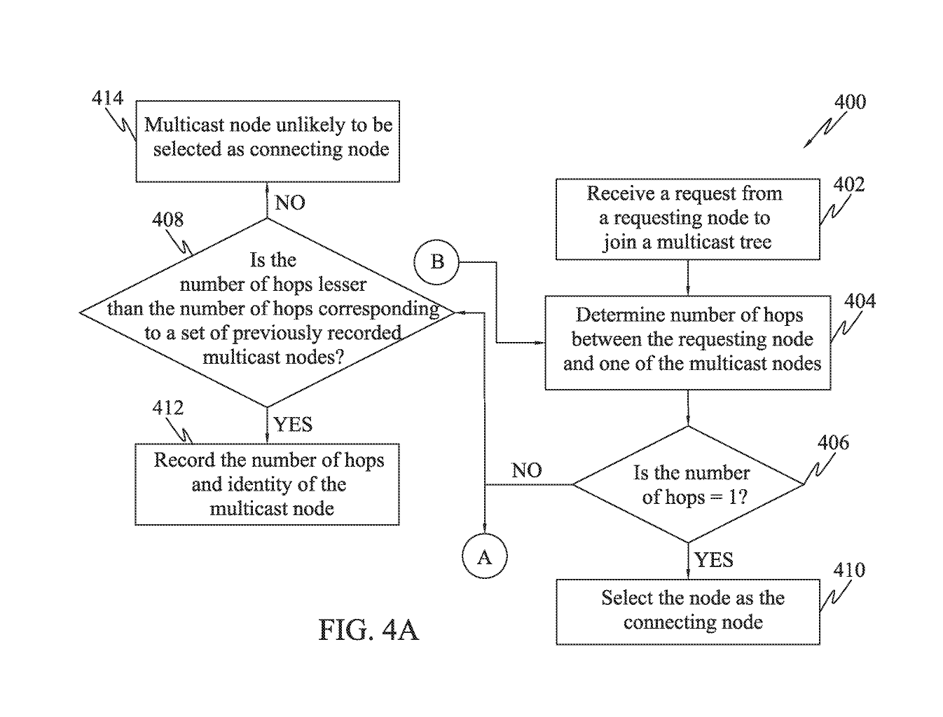

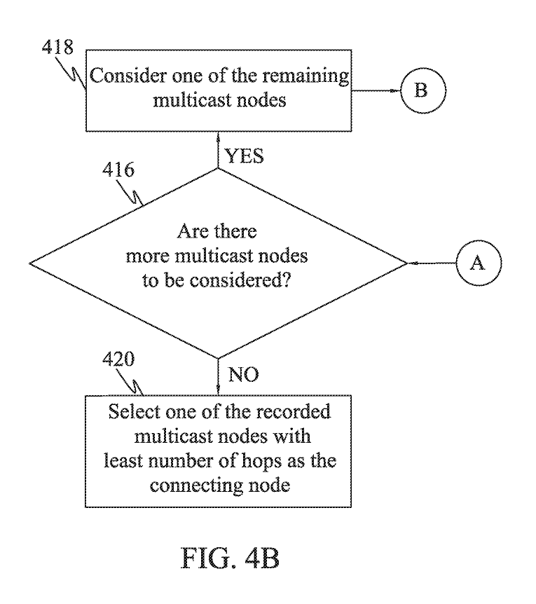

Referring to FIGS. 4A and 4B, a flowchart illustrates a method 400 of addition of one or more nodes to the multicast tree M. The node, which may be referred to as requesting node, is not a member of the multicast tree M yet and has requested to join the multicast. The controller 102 receives the request, computes the shortest path from one of the multicast nodes to the requesting nodes and defines a path to the requesting node from the multicast node. The steps will be elaborated with the subsequent sections.

At step 402, the controller 102 receives a request from a requesting node to join an existing multicast tree (M). At step 404, the number of hops between the requesting node and one of the multicast nodes is determined. At step 406, it is determined whether the number of hops between requesting node and one of the multicast nodes is 1. If it is determined that, the number of hops is 1, then, at step 410, the multicast node, which is 1 hop away from the requesting node, is selected as the connecting node.

If it is determined that, the number of hops is not 1, at step 406, then the process moves to step 408. At step 408, the controller 102 determines whether the number of hops is lesser than the number of hops corresponding to a set of previously recorded multicast nodes. The controller 102 records the number of hops and identity of the multicast node, at step 412, if number of hops is lesser than the number of hops corresponding to a set of previously recorded multicast nodes. If not, then at step 414, the multicast node is considered unlikely to be selected as connecting node. The process may proceed to step 416 where the controller 102 may determine if there are more multicast nodes to be considered. If at step 416, it is determined that there are more multicast nodes to be considered, then the process moves to step 418 to consider one of the remaining multicast nodes and subsequently the process repeats from step 404. If at step 416 it is determined that there are no more multicast nodes to be considered, then one of the recorded multicast nodes with least number of hops is selected as the connecting node, at step 420.

The controller 102 may terminate determining number of hops between the requesting node and multicast nodes if the controller 102 identifies at least one multicast node which is one hop away from the requesting node. Additionally, the controller 102 continues determination of number of hops between all multicast nodes in a network and the requesting node until a single hop node is identified. Upon failing to identify a single hop multicast node, the controller 102 considers another node for selection as the connecting node, among the multicast nodes, which is next least number of hops away from the requesting node.

The controller 102 records the identity and number of hops corresponding to multicast nodes which have been identified to be relatively least number of hops away from the requesting node. Additionally, the controller 102 records identity and number of hops corresponding to the multicast nodes if the number of hops leading to the multicast nodes is lesser than the number of hops corresponding to a set of previously recorded multicast nodes.

As an example, upon receiving a request from a requesting node to join the multicast tree, the controller attempts to find the shortest path to a multicast node from the requesting node. Let's assume, a node is determined by the controller 102, which is three hops away from a requesting node. The controller 102 records the identity of the node, which is three hops away from a requesting node. Further, the controller continues determining the number of hops to the rest of the nodes in the multicast tree until a node, which is one hop away from the requesting node, is identified. Let's assume, the next node, identified by the controller 102 is one hop away from the requesting node. The controller 102 records the identity of the single hop node and ignores the node, which is three hops away from the requesting node, to be selected as the connecting node.

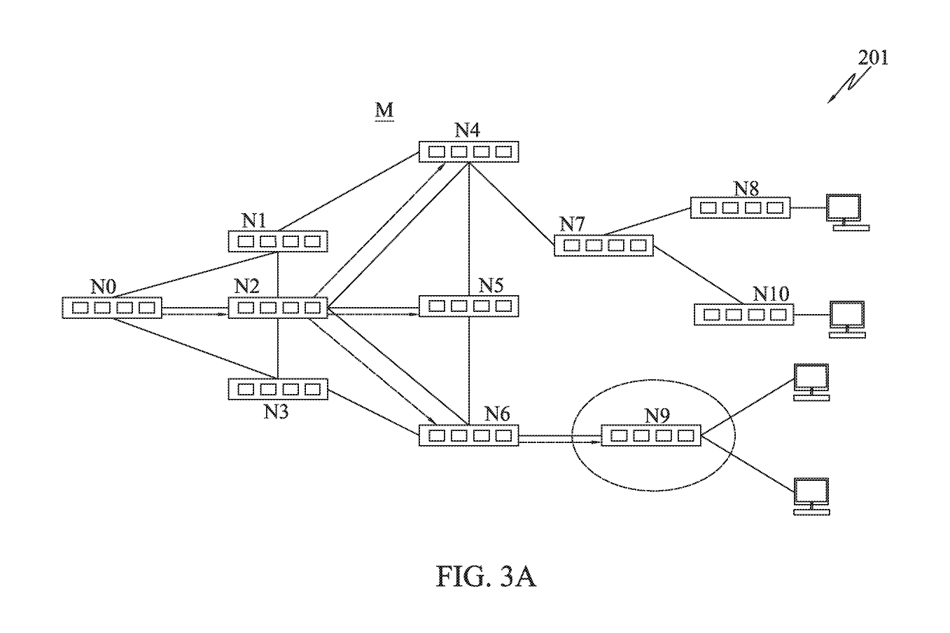

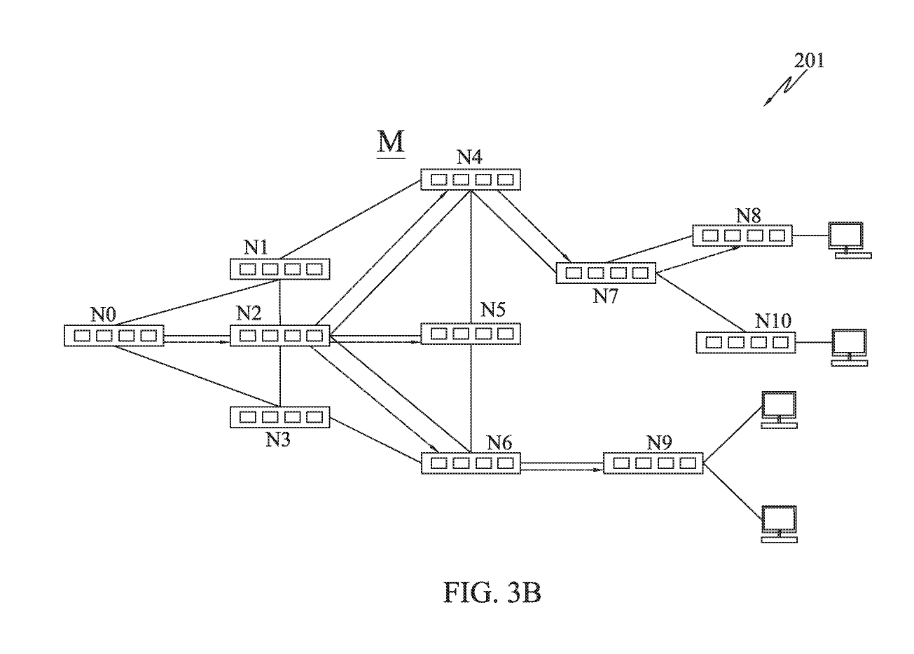

Referring to FIG. 3A, let's assume the controller 102 receives request from a requesting node (N9). The requesting node (N9) is a node outside the multicast tree M but within the network infrastructure 201 and wishes to receive data from the multicast tree M.

The controller 102 determines the number of hops from node N9 to one or more of the multicast nodes N0, N2, N4, N5 and N6, which are members of the multicast tree M. Let's assume, the controller 102 determines number of hops from node N9 to node N4 while attempting to select the connecting node. The number of hops from node N9 to node N4 is determined to be 3 hops. The controller 102 records the identity of node N4 and the corresponding number of hops.

Subsequently, let's assume, the number of hops from N9 to N2 is determined to be 2 hops. The controller 102 records the identity of node N2 and the corresponding number of hops.

The controller 102 may ignore N4 from being considered as a candidate for selection as a connecting node, since N2 is relatively less number of hops away. In some implementations, as an example, the controller 102 may still retain the identities of N2 and N4 as possible candidates.

Let's suppose the next multicast node considered by the controller 102 is N6. The controller 102 determines the number of hops between N9 and N6. The number of hops is determined to be 1. The controller 102 selects node N6 as the connecting node. The controller 102 may now terminate the process of determining the number of hops from the remaining multicast nodes, since a single-hop node, N6, has been identified.

In an embodiment, the controller 102 may traverse back from the requesting node N9 towards the source node N0 to identify multicast nodes, which may have to be considered to select one of them as the connecting node. In this example, N6 may be considered in the first instance, in contrast to the previous example.

Referring to FIG. 3B, let's assume N8 is a node outside the multicast tree M, requesting to join the multicast. Nodes N0, N2, N4, N5, N6 and N9 are the multicast nodes and are members of the multicast tree M. A request to join multicast tree M may be received from node N8. The controller 102 may select the connecting node for node N8 by determining the shortest path between the node N8 and any multicast node, which are members of the multicast tree M.

As seen in FIG. 3B, multicast node N7 is the nearest node, which is one hop away from node N8. However, node N7 is not a member of the multicast tree M. In this example, as can be seen, none of the multicast nodes are single hop away from the requesting node N8, and hence, the controller 102 may end up determining number of hops to each of N0-N4. The controller 102, identifies that, among the multicast nodes, N4 is the least number of hops (2 hops via N7) away from the requesting node N8. Hence, N4 is selected as the connecting node. Data flow path is established between N4 and N8. The flow tables of N4, N7 and N8 may be updated by the controller 102 to establish the new flow path.

VII. Deletion of Existing Nodes from Multicast Tree

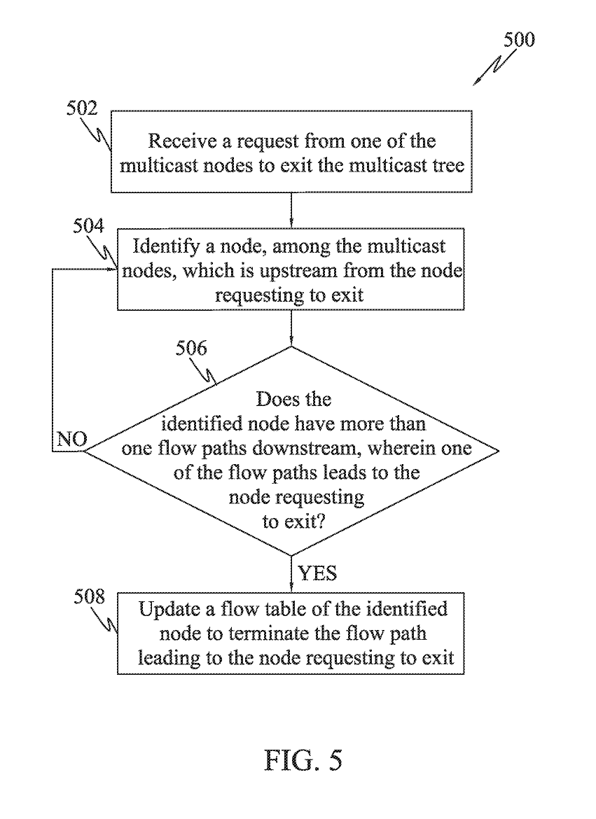

Referring to FIG. 5, a flowchart illustrates a method 500 for deleting a multicast node from the multicast tree M. At step 502, the controller 102 receives a request from one of the multicast nodes to exit the multicast tree M. It shall be noted that only a terminal multicast node that does not send data to any other multicast node within the tree M may request to leave the multicast tree M. A terminal node may be a node to which end user's (client's) devices are connected (e.g. N9, N8, N10). At step 504 a node, among the multicast nodes is identified, which is (immediately) upstream from the node requesting to exit. At step 506, a determination is made whether the identified node enables more than one flow paths downstream, wherein one of the flow paths leads to the node requesting to exit. If at step 506, it is determined that the identified node is configured to enable additional flow paths downstream apart from the path leading to the node requesting to exit, then the controller 102 updates the flow table of the identified node to terminate the flow path leading to the node requesting to exit. If at step 506, it is determined that the identified node does not include additional flow paths downstream apart from the path leading to the node requesting to exit, the controller 102 moves to step 504 to identify another node, among the multicast nodes, which is further upstream from the node requesting to exit. In this step, the controller 102 may be configured to identify a subsequent upstream node through which more than one flow paths are enabled.

In an embodiment, the controller 102 receives a request from one of the multicast nodes to exit the multicast tree M. An attempt is made to identify a multicast node, which is immediately upstream with respect to the node requesting to exit, at which the data flow path diverges into more than one paths. The controller 102 continues the process of identifying a node at which flow path diverges, thereby moving further upstream in the multicast tree M. Once a multicast node at which flow path diverges, is located or identified, the controller 102 updates the flow table at the identified node. The flow path, leading to the node requesting to exit, will terminate packet flow or stop sending packets to the node requesting to exit.

Referring to FIG. 3B, let us assume that the multicast node N8 is requesting to leave the multicast tree M. The controller 102 receives a request from the multicast node N8 to exit the multicast tree M. The controller 102 identifies a node, among the other multicast nodes, which is immediately upstream from the node requesting to exit. The node which is immediately upstream from N8 is N7. The controller 102 further determines if the node N7 enables more than one flow paths downstream, wherein one of the flow paths leads to the node requesting to exit. Node N7 enables only one flow path, leading to node N10. Hence, the controller now considers node N4, which is further upstream. At node N4 data flow paths diverge, one leading to N8, via N7, and the other to a client device, as an example, which had requested to be part of the multicast, because of which N4 was made part of the multicast tree. Hence, flow table at node N4 is updated to terminate data flow to N7, thereby terminating data flow to N8. The controller 102 may also update the flow tables of N7 and N8.

### VIII. Conclusion

Embodiments enable multicast in an OpenFlow network.

Embodiments enable encapsulating data packets into a tunnel at a source node and providing a unique identification to the tunnel.

Embodiments enable each multicast node to carry out actions as per a flow table by identifying the tunnel.

Embodiments enable updating flow tables at those multicast nodes where actions are to be carried out as per the flow table.

Embodiments enable addition of nodes to a multicast tree.

Embodiments enable selection of a connecting node which is least number of hops away from a node requesting to join a multicast tree.

Embodiments enable deletion of nodes from the multicast tree.

Embodiments enable identification of a multicast node, which is immediately upstream with respect to the node requesting to exit, at which the data flow path diverges into more than one paths, such that the data flow path is terminated at that multicast node.

Embodiments enable expansion of the multicast tree without disturbing existing data flow paths.

Embodiments enable relatively better utilization of network bandwidth.

The processes described above is described as sequence of steps, this was done solely for the sake of illustration. Accordingly, it is contemplated that some steps may be added, some steps may be omitted, the order of the steps may be re-arranged, or some steps may be performed simultaneously.

The example embodiments described herein may be implemented in an operating environment comprising software installed on a computer, in hardware, or in a combination of software and hardware.

Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

Many alterations and modifications of the present invention will no doubt become apparent to a person of ordinary skill in the art after having read the foregoing description. It is to be understood that the phraseology or terminology employed herein is for the purpose of description and not of limitation. It is to be understood that the description above contains many specifications, these should not be construed as limiting the scope of the invention but as merely providing illustrations of some of the personally preferred embodiments of this invention.

What is claimed is:

1. A system for enabling multicast in an OpenFlow network, the system comprising a controller (102) configured to:
receive a request from a requesting node to join an existing multicast tree;
select a connecting node, wherein,
the connecting node is selected among multicast nodes, wherein the multicast nodes are part of the multicast tree; and
the connecting node is least number of hops away from the requesting node; and
define a data flow path between the requesting node and the connecting node,
thereby maintaining a non-disruptive packet flow in the multicast tree.

2. The system of claim 1, wherein the controller (102), to select the connecting node, is configured to:
determine number of hops between the requesting node and one or more of the multicast nodes;
terminate determination of number of hops between the requesting node and the multicast nodes, once a single-hop node is identified among the multicast nodes, wherein the single-hop node is one hop away from the requesting node; and
select the single hop node as the connecting node.

3. The system of claim 1, wherein the controller (102), to select the connecting node, is configured to:
determine number of hops between the requesting node and the multicast nodes sequentially;
record identity and number of hops corresponding to multicast nodes which have been identified to be relatively least number of hops away from the requesting node; and
terminate determination of number of hops between the requesting node and the multicast nodes, once a single-hop node is identified among the multicast nodes, wherein the single-hop node is one hop away from the requesting node.

4. The system of claim 3, wherein the controller (102) is configured to, select the multicast node whose identity and the number of hops has been recorded, as the connecting node, if the single-hop node is absent.

5. The system of claim 1, wherein the controller (102) is configured to:
encapsulate data packets to create a tunnel;
provide an identification to the tunnel; and
update flow tables at the multicast nodes, wherein each of the multicast nodes carries out actions as per the flow table by identifying the tunnel by its identification.

6. The system of claim 5, wherein the controller (102) is configured to:
establish a single flow path between the multicast nodes; and
update the flow tables of those multicast nodes where data flow diverges into two or more paths, to create as many copies of the data packets as the number of paths the data flow is diverging at respective multicast nodes.

7. The system of claim 1, wherein the controller (102) is configured to:
receive a request from one of the multicast nodes to exit the multicast tree;
identify a node, among the multicast nodes, which is:
immediately upstream from the node requesting to exit; and
configured to enable more than one flow paths downstream, wherein one of the flow paths leads to the node requesting to exit; and
update a flow table of the identified node to terminate the flow path leading to the node requesting to exit.

8. The system of claim 1, wherein the controller (102) is further configured to:
receive a request to create a multicast tree, wherein the multicast tree is to be created with a source node and a plurality of destination nodes;
receive flow paths between the source node and each of the destination nodes, wherein each flow path comprises least possible number of hops between the source node and respective destination node;
identify common links in the flow paths between the source node and each of the destination nodes; and
define data flow paths between the source node and each of the destination nodes, wherein single data flow is established in the common links as well.
